(19) United States
(12) Patent Application Publication
(10) Pub. No.: US 2018/0342092 A1
(43) Pub. Date: Nov. 29, 2018

(54) COGNITIVE INTEGRATED IMAGE CLASSIFICATION AND ANNOTATION

(71) Applicant: INTERNATIONAL BUSINESS MACHINES CORPORATION, Armonk, NY (US)

(72) Inventors: Kristina Y. Choo, Chicago, IL (US); Rashida A. Hodge, Ossining, NY (US); Krishnan K. Ramachandran, Campbell, CA (US); Gandhi Sivakumar, Bentleigh (AU)

(21) Appl. No.: 15/606,019

(22) Filed: May 26, 2017

(51) Int. Cl. G06T 11/60; G06K 9/62

(52) U.S. Cl. CPC G06T 11/60; G06T 1/20; G06K 9/6267

(57) ABSTRACT

A system for classifying and tagging digital images includes: a CPU, a computer readable memory, and a computer readable storage medium associated with a computer device; program instructions defining plural pipelines each configured to classify and tag aspects of the image, wherein a first one of the plural pipelines is configured to classify and tag an object in the image, and a second one of the plural pipelines is configured to classify and tag a kinematic aspect of the object in the image; program instructions defining a controller configured to: pass the image to each of the plural pipelines in a predefined order; and output an annotation of the image to a user interface. The program instructions are stored on the computer readable storage medium for execution by the CPU via the computer readable memory.

### BACKGROUND

The present invention generally relates to computer-based systems and methods for automatic image classification and annotation and, more particularly, to cognitive integrated image classification and annotation.

Image classification includes a broad range of decision-theoretic approaches to the identification of images or parts thereof. Classification algorithms are generally based on the assumption that the image depicts one or more features, and that each of these features belongs to one of several distinct classes. The classes may be specified a priori by an analyst, as in supervised classification or automatically clustered into sets of prototype classes, as in unsupervised classification, where the analyst merely specifies the number of desired categories.

Image classification analyzes numerical properties of various image features and organizes data into categories. Supervised classification algorithms typically employ two phases of processing: training and predicting. In the initial training phase, characteristic properties of typical image features are isolated from a plurality of images that correspond to the class and, based on these, a unique description of each classification category, i.e. training class, is created. In the subsequent predicting phase, these feature-space partitions are used to classify image features. Unsupervised classification algorithms typically do not utilize a training set but rather are configured to automatically discover structure in data provided thereto in order to generalize mapping from inputs to outputs. In order that such generalization be accurate, a plurality of representative images from each class is processed.

Automatic image annotation (also referred to as automatic image tagging or linguistic indexing) is the process by which a computer system automatically assigns metadata in the form of captioning or keywords (e.g., tags) to a digital image. This method can be regarded as a type of multi-class image classification with a very large number of classes. Typically, image analysis in the form of extracted feature vectors and the training annotation words are used by machine learning techniques to attempt to automatically apply annotations to new images. For example, a user can feed a static image into the system, and the system returns a result such as: “man, age around 40 years old, bald.”

### SUMMARY

In a first aspect of the invention, there is a method for classifying and annotating an image. The method includes receiving, by a computer device and from a user interface, an input of an image. The method also includes generating an annotation of the image, by the computer device, by passing the image to plural separate pipelines and tag libraries, wherein the plural separate pipelines and tag libraries comprise: a pipeline configured to classify and tag objects in the image; and a pipeline configured to tag kinematic aspects of the objects in the image. The method additionally includes outputting, by the computer device, the annotation to the user interface.

In another aspect of the invention, there is a system for classifying and tagging digital images. The system includes: a CPU, a computer readable memory, and a computer readable storage medium associated with a computer device; program instructions defining plural pipelines each configured to classify and tag aspects of the image, wherein a first one of the plural pipelines is configured to classify and tag an object in the image, and a second one of the plural pipelines is configured to classify and tag a kinematic aspect of the object in the image; and program instructions defining a controller configured to: pass the image to each of the plural pipelines in a predefined order; and output an annotation of the image to a user interface. The program instructions are stored on the computer readable storage medium for execution by the CPU via the computer readable memory.

In another aspect of the invention, there is a computer program product for classifying and tagging digital images. The computer program product comprises a computer readable storage medium having program instructions embodied therewith. The program instructions are executable by a computer device to cause the computer device to: receive an input of an image from a user interface; tag the image with at least one object tag using an object tagging pipeline; tag the image with at least one kinematic tag using a kinematic tagging pipeline; obtain at least one insight about the image from a big data platform; tag the image with at least one personalized object tag based on at least one object tag and the at least one insight; generate an annotation of the image based on the at least one personalized object tag and the at least one kinematic tag; and output the annotation to the user interface.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows a block diagram of a system in accordance with aspects of the invention.

FIGS. 3A, 3B, and 3C show exemplary environments in accordance with aspects of the invention.

FIG. 4 shows a flowchart of an exemplary method in accordance with aspects of the invention.

### DETAILED DESCRIPTION

The present invention generally relates to computer-based systems and methods for automatic image classification and annotation and, more particularly, to cognitive integrated image classification and annotation. Implementations of the invention provide a computer based system into which a user may input an image, wherein the system automatically outputs an annotation (e.g., text description, tags, etc.) of the image. Embodiments may also be used to annotate a sequence of plural images. Aspects of the invention are directed to classifying and annotating an image based on: kinematic variations (e.g., speaking, walking, driving, etc.), environment within perspective (e.g., walking on a sunny day, snowy day), dynamic big data personalized engines (e.g., identifying objects of interest), running representation-based capabilities (e.g., when an indentified person had a different hair style compared to the current image fed in), and time-based capabilities (e.g., a person was younger in the image than they are now).

According to aspects of the invention, a template based approach is used to identify an object in an image, the object's kinematics, and related entities. In embodiments, a pipeline based approach is used in which plural different pipelines utilize templates to determine different types of classifications of one or more objects in the image. Each pipeline may include a respective tag library, and may annotate one or more tags to the image from the respective tag library.

In an exemplary implementation, there is a cognitive computing engine including a classification and tagging (i.e., annotation) pipeline configured to include tagging modules that use image analysis to tag (e.g., classify) features of a static image, wherein the modules are capable of using external context (e.g., known historical information about objects in the image, changes in time or space, prior analyzed images) in performing the tagging. The tagging modules may include: a kinematic tagging module configured to tag motions (e.g., kinematic variations) performed by objects within the image (e.g., tag bird as “flying”, tag man as “running”); a personalized tagging module configured to tag objects based on the relationship of the user of the system to the object and/or preferences of the user about the object (e.g., tag woman as “mother”, tag a dog as “Fido”, tag black jelly bean as “bad tasting”); and an age/time change tagging module configured to tag an object as being a different age (or at a different time) than at present based on differences in appearance from the object's current form (e.g., tag a person in the image as “Tom when he was younger”). The tagging modules may use comparisons to (i) previously tagged images or (ii) templates of objects to make tagging determinations (e.g., tags are relative to the tags applied in previous images of the same objects or relative to the tag associated with the template of the same object).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

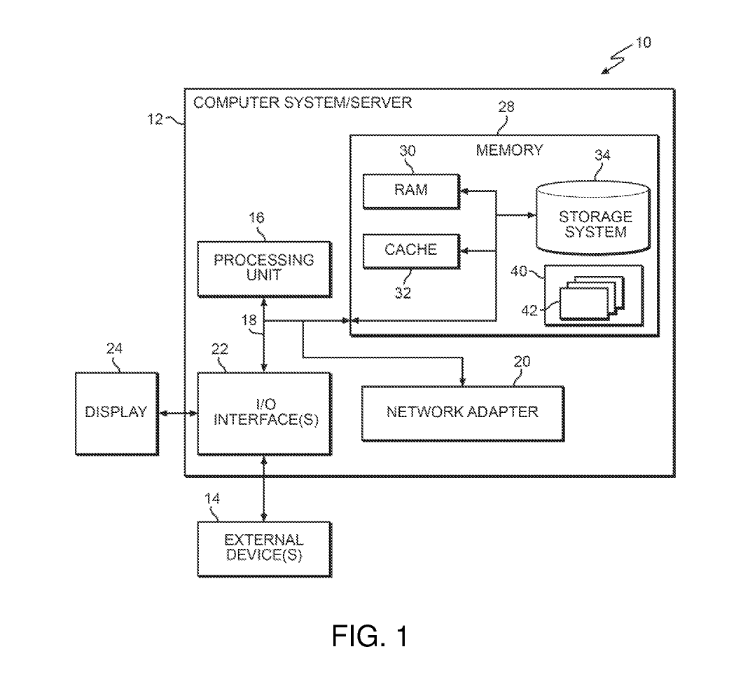

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

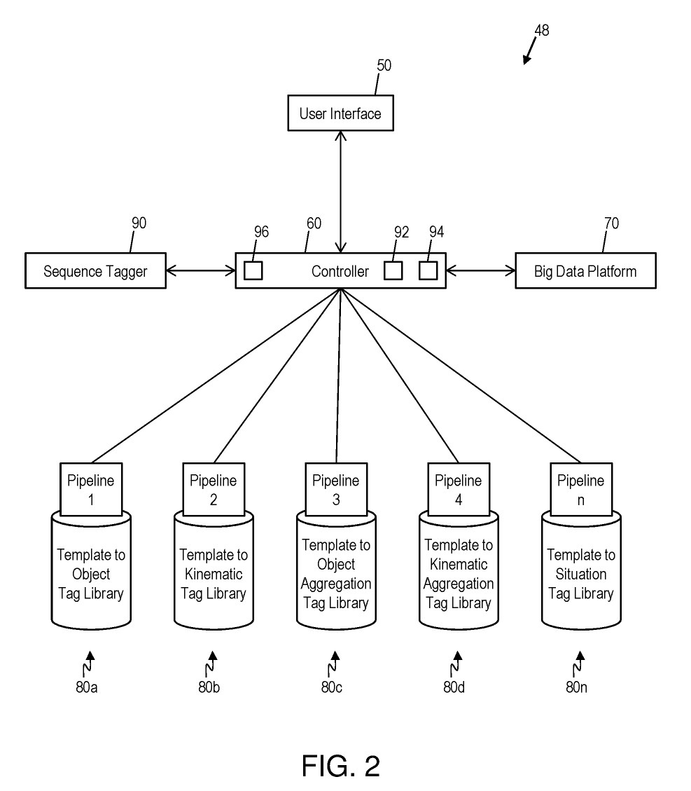

FIG. 2 shows a block diagram of a system 48 in accordance with aspects of the invention. As shown in FIG. 2, the system may include a user interface (UI) 50, a controller 60, a big data platform 70, a number of pipelines and tag libraries 80a-n, and a sequence tagger 90. The system 48 is configured to receive an image (e.g., a digital image) via the user interface 50, automatically annotate the image with tags, and output the image with annotations (tags) at the user interface 50. In this manner, an individual may use the system 48 to obtain a text-based description of images that are input into the system 48.

In embodiments, the user interface 50 is a graphic user interface (GUI) referred to herein as a “Cognitive Image Classifier” (CIC). In accordance with aspects of the invention, the user interface 50 receives the image as input and feeds the image to the controller 60 to be classified by the various pipelines and tag libraries 80a-n. The user interface 50 may be displayed at a user computer device, which may be similar to the computer system 12 of FIG. 1. For example, the user interface 50 may be presented on a laptop computer, desktop computer, tablet computer, smartphone, etc. The user interface 50 may use conventional techniques for permitting a user to indicate an image (or plural images) to be classified and annotated by the system 48. As but one example, the user interface 50 may be configured to permit a user to “Browse” the storage of the user computer device to indicate an image to be classified and annotated.

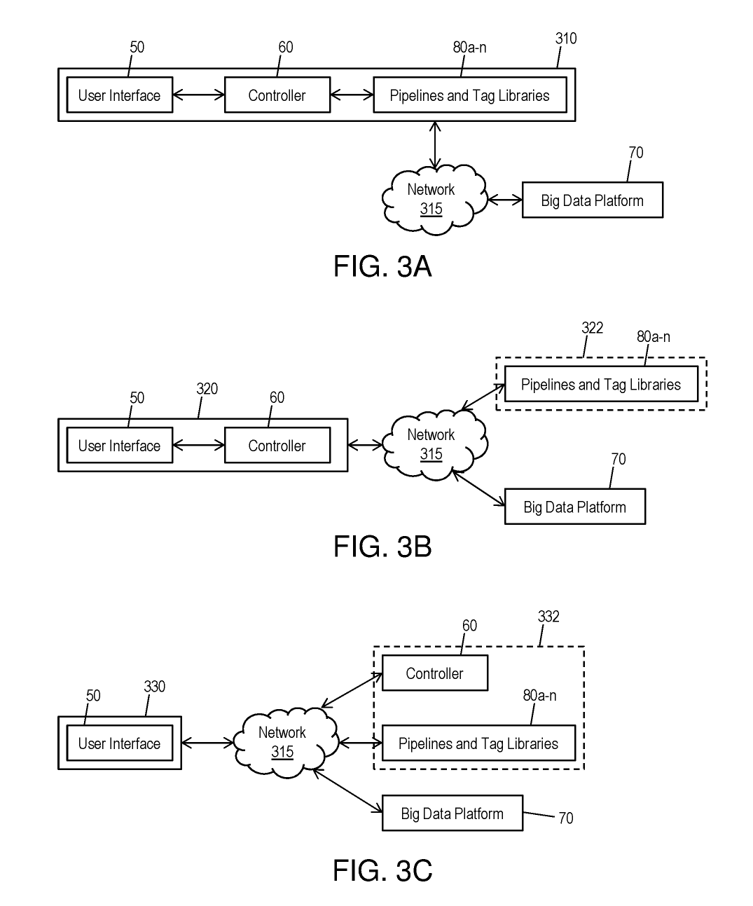

In accordance with aspects of the invention, the controller 60 functions as a mediator between the user interface 50 and the pipelines and tag libraries 80a-n. The controller 60 may be embodied as one or more program modules (e.g., program modules 42 of FIG. 1) that are configured to: receive an image from the user interface 50; provide the image to the pipelines and tag libraries 80a-n in a sequence defined by the sequence tagger 90; optionally obtain big data insights from the big data platform 70; and return the tagged image to the user interface 50. The controller 60 may reside at a same computer device as the user interface 50 or at a different computer device, as described herein with respect to FIGS. 3A-C.

Still referring to FIG. 2, the pipelines and tag libraries 80a-n represent plural discrete tagging modules through which the image is classified and annotated. Each respective pipeline may be embodied as one or more program modules (e.g., program modules 42 of FIG. 1) that are configured to classify particular aspects of the image and annotate the image with one or more tags from the tag library associated with the respective pipeline. For example, in embodiments, “Pipeline 1” is an object tagging pipeline that is configured to classify one or more objects in the image and to annotate the one or more objects with one or more tags from the “Template to Object Tag Library” based on the classification. In accordance with aspects of the invention, “Pipeline 1” classifies objects in the image using template-based classification techniques. For example, “Pipeline 1” may be programmed to extract an object from the image (e.g., using conventional shape extraction techniques such as edge detection) and compare the object to a set of predefined object templates. Each of the predefined object templates is associated with one or more tags (e.g., man, woman, bird, horse, dog, cat, etc.) in the “Template to Object Tag Library”. When an extracted object is determined to match one of the predefined object templates, the image is annotated (tagged) with the one or more tags associated with the matching one of the predefined object templates. In this manner, each object in the image may be classified and tagged, e.g., as man, woman, bird, horse, dog, cat, etc.

According to aspects of the invention, “Pipeline 1” is configured to extract plural objects from the image and classify and tag each object independently of the other extracted objects. For example, for an image that shows a man walking with a dog, “Pipeline 1” would operate to extract the first object and tag this object with the tag “man”, and would operate to extract the second object and tag this object with the tag “dog”. In this manner, each object in the image may be classified and tagged.

Implementations of the invention are not limited to the object tags described in this example (e.g., man, woman, bird, horse, dog, cat). In practice, “Pipeline 1” and the “Template to Object Tag Library” may be trained with any desired number and type of object templates with associated object tags. As used herein, template based classification of objects refers to classification based on the shape (e.g., outline) of the object in the image, as opposed to classification based on comparing the extracted object to plural photographs of objects. In embodiments, colors in the image may be used for extracting objects (e.g., via edge detection), however the classification of objects is not based on the colors of the object but rather is based on the shape (e.g., outline) of the object.

In embodiments, “Pipeline 2” is a kinematic tagging pipeline that is configured to classify a kinematic aspect of the one or more objects in the image and to annotate the one or more objects with one or more tags from the “Template to Kinematic Tag Library” based on the classification. In aspects, “Pipeline 2” is programmed to tag each object that was classified and tagged in “Pipeline 1” with one or more kinematic tags that define motions such as walking, running, standing, sitting, jumping, swimming, perching, taking off, flying, etc. For example, “Pipeline 1” may tag a first object in the image as “man” and a second object in the image as “dog”, and “Pipeline 2” may tag the first object as “running” and the second object as “sitting”.

In accordance with aspects of the invention, “Pipeline 2” uses template based techniques (e.g., in a manner similar to “Pipeline 1”) for classifying and tagging the kinematic aspects of the identified objects in the image. In practice, “Pipeline 2” and the “Template to Kinematic Tag Library” may be trained with any desired number and type of kinematic templates with associated kinematic tags. For example, “Pipeline 2” may include plural kinematic template variations for bird kinematics (e.g., perching, taking off, and flying), plural kinematic template variations for human kinematics (e.g., walking, running, standing, sitting, jumping, swimming), and so on corresponding to the types of objects defined in the object tagging module.

In embodiments, “Pipeline 3” is configured to classify an aggregation of the one or more objects in the image and to annotate the one or more objects with one or more tags from the “Template to Object Aggregation Tag Library” based on the classification. In aspects, “Pipeline 3” leverages the image source specification template and compares the aggregation template, e.g., to determine whether plural objects in the image correspond to a predefined object aggregation template. For example, “Pipeline 1” may tag plural objects in the image as “bird”, and “Pipeline 3” may tag the plural bird objects as “swarm” based on comparing to a swarm template. In practice, “Pipeline 3” and the “Template to Object Aggregation Tag Library” may be trained with any desired number and type of object aggregation templates with associated object aggregation tags.

In embodiments, “Pipeline 4” is configured to classify an aggregation of a kinematic aspect of the one or more objects in the image and to annotate the one or more objects with one or more tags from the “Template to Kinematic Aggregation Tag Library” based on the classification. For example, “Pipeline 1” may tag plural objects in the image as “bird”, and “Pipeline 4” may tag a first subset of the birds objects as “birds perching”, a second subset of the bird objects as “birds taking off” and a third subset of the bird objects as “birds flying”. In this manner, the system may classify and tag respective groups of objects that are performing a same kinematic variation.

In embodiments, “Pipeline n” is configured to classify a situation in the image and to annotate the situation with one or more tags from the “Template to Situation Tag Library” based on the classification. As used herein, a situation may refer to an environmental aspect (e.g., beach, water, mountains, city, etc.) and/or a weather aspect (e.g., sunny, cloudy, raining, snowing, windy, etc.). For example, “Pipeline 1” may tag an object in an image as “man”, “Pipeline 2” may tag the same object as “walking”, and “Pipeline n” may tag the same image as “at the beach” and “sunny day”. In this example, the controller 60 would combine the tags to produce an output of “man walking on the beach on a sunny day”. The classification and tagging according to situation may be performed using template based techniques (e.g., in a manner similar to “Pipeline 1”) or other classification techniques.

According to aspects of the invention, the system 48 uses the respective pipelines and tag libraries 80a-n to provide a modular approach to classifying and tagging different aspects of an object in the image, as opposed to systems that determine all tags for an object in a single process. Implementations of the invention are not limited to the number of pipelines and tag libraries 80a-n shown in FIG. 2, and fewer or more may be used. Moreover, different types of pipelines and tag libraries (e.g., different than those shown) may be used. In embodiments, the sequence tagger 90 stores data defining the sequence (e.g., order) in which the controller 60 sends the image to the various pipelines and tag libraries 80a-n.

With continued reference to FIG. 2, in accordance with aspects of the invention, the controller 60 interfaces with the big data platform 70 to obtain insights about one or more objects in the image that is input by the user at the user interface 50, and uses one or more of the insights in annotating (tagging) the image. The big data platform 70 (also referred to as a big data engine) obtains and analyzes data from plural disparate sources including but not limited to: social media sources (user social media posts, comments, follows, likes, dislikes, etc.); social influence forums (e.g., user comments at online blogs, user comments in online forums, user reviews posted online, etc.); activity-generated data (e.g., computer and mobile device log files including web site tracking information, application logs, sensor data such as check-ins and other location tracking, data generated by the processors found within vehicles, video games, cable boxes, household appliances, etc.); Software as a Service (SaaS) and cloud applications; transactions (e.g., business, retail, etc.); emails; social media; sensors; external feeds; RFID (radio frequency identification) scans or POS (point of sale) data; free-form text; geospatial data; audio; still images and videos.

Big data, by definition, involves data sets that are so large or complex that traditional data processing application software is incapable of obtaining and analyzing the data. As such, it follows that the big data platform 70 is necessarily rooted in computer technology since the processes involved are impossible to perform without computer technology (i.e., the processes involved in obtaining and analyzing big data cannot be performed in the human mind). In embodiments, the big data platform 70 includes a plurality of computer devices (e.g., servers) arranged in a distributed network (e.g., a cloud environment).

In embodiments, the controller 60 provides the image and the identity of the user (i.e., the user who inputs the image at the user interface 50) to the big data platform 70. Using this information, the big data platform 70 may use big data analytics to obtain insights about one or more of the objects in the image (e.g., one or more of the objects classified and tagged in “Pipeline 1”). For example, based on the user identity and the tagged objects, the big data platform 70 may analyze data such as the user's social media, still images, and videos, as well as text, comments, tags, dates, and ages associated with the social media, still images, and videos, to determine insights about the tagged objects in the image. The insights may include, for example, the name of one or more people in the image, relationships between people in the image (e.g., friend, husband, wife, co-worker, etc.), the age of one or more people in the image, the name of one or more animals (e.g., pets) in the image, the name of one or more locations in the image (e.g., home, office, etc.).

According to aspects of the invention, the big data platform 70 transmits the determined insights to the controller 60, and the controller 60 uses the insights in annotating the image. For example, the controller 60 may include a personalized tagging module 92 that is configured to tag one or more objects in the image based on the relationship of the user to the object (e.g., tag woman as “mother”, tag a dog as “Fido”, etc.) and/or preferences of the user about the object (e.g., tag black jelly bean as “bad tasting”) based on the insights obtained from the big data platform 70. For example, “Pipeline 1” may tag a first object in an image as “woman” and a second object in the image as “dog”. The controller 60 may send the image (including an indication of the tagged objects) to the big data platform 70, along with the identity of the user. The big data platform 70 may return insights that the first object is the user's mother and that the second object is the user's pet named Fido. Based on these insights, the personalized tagging module 92 may replace the generic object tags with personalized tags. In this example, based on the insights, the personalized tagging module 92 replaces the first object tag “woman” with the tag “mother”, and replaces the second object tag “dog” with the tag “Fido”. In this manner, the classification and annotation of the image may be personalized to the user based on analyzing big data associated with the user.

As another example of using big data insights to annotate the image, the controller 60 may include an age/time change tagging module 94 configured to tag an object as being a different age (or at a different time) than at present based on differences in appearance from the object's current form (e.g., tag a person in the image as “Tom when he was younger”). For example, “Pipeline 1” may tag an object in an image as “man”. The controller 60 may send the image (including an indication of the tagged objects) to the big data platform 70, along with the identity of the user. The big data platform 70 may return insights that the object tagged as “man” is the user at a different age (e.g., based on images, dates, and text of the user's social media). Based on these insights, the age/time change tagging module 94 may replace the generic object tag (“man”) with a personalized age/time change tag (“Tom when he was younger”).

According to aspects of the invention, as described with respect to modules 92 and 94, the controller 60 thus may be configured to: obtain an insight about the object in the image from a big data platform; and adjust an object tag of the image based on the insight. The adjusting the object tag comprises replacing a generic object tag (from “Pipeline 1”) with one of a name (e.g., “Fido”), a relationship (e.g., “mother”), and an age descriptor (e.g., “Tom when he was younger”) based on the insights. Tags that are applied based on the insights may be referred to as personalized object tags. As such, the controller 60 may be configured to: tag the image with at least one object tag using an object tagging pipeline (e.g., “Pipeline 1”); tag the image with at least one kinematic tag using a kinematic tagging pipeline (e.g., “Pipeline 2”); obtain at least one insight about the image from a big data platform 70; tag the image with at least one personalized object tag based on at least one object tag and the at least one insight; and generate an annotation of the image based on the at least one personalized object tag and the at least one kinematic tag.

According to further aspects of the invention, the controller 60 may include a sequence tagging module 96. In embodiments, the user interface 50 may permit a user to input plural images, such as a sequence of images. Based on receiving a sequence of images from the user interface 50, the controller 60 passes each respective image in the sequence to the pipelines and tag libraries 80a-n. For example, the controller passes the first image in the sequence to the pipelines and tag libraries 80a-n for classification and tagging as described herein. After classifying and tagging the first image, the controller passes the second image in the sequence to the pipelines and tag libraries 80a-n for classification and tagging as described herein. In this manner, each image in the sequence of images is classified and tagged.

In accordance with aspects of the invention, the sequence tagging module 96 is configured to compare the tags of consecutive images in the sequence and eliminate redundant tags in a subsequent image. For example, a first image of the sequence may be tagged as “man walking, dog walking” and the second image of the sequence may be tagged with “man standing, dog walking”. In this sequence, the “dog walking” tag does not change from the first image to the second image, and therefore can be omitted from the second image. Accordingly, in this example, the sequence tagging module 96 would modify the tags such that the output for the sequence of images is “man walking and dog walking, then man standing”.

According to aspects of the invention, the controller 60 is configured to collect all the tags (e.g., those applied by the various pipelines and tag libraries 80a-n, and those applied by the any of the modules 92, 94, 96) and create an annotation for the image (or sequence of images). In one embodiment, the annotation comprises the applied tags separated by commas. In another embodiment, the annotation comprises the applied tags structured in a sentence form (e.g., the controller 60 may arrange the tags in a sentence form using sentence construction techniques). In either embodiment, the controller 60 outputs the image and the annotation to the user interface 50, where the image and the annotation are output (e.g., displayed, printed, etc.) to the user.

FIGS. 3A-C show exemplary environments in accordance with aspects of the invention. The arrangements illustrated in FIGS. 3A-C are not intended to be limiting, and other implementations of the elements of the system may be employed.

FIG. 3A illustrates an implementation in which the interface 50, the controller 60, and the pipelines and tag libraries 80a-n all reside on a single computer device 310 (which may be similar to computer system 12 of FIG. 1). The computer device 310 communicates with the big data platform 70 via a network 315. The network 315 may be any suitable network such as a LAN, WAN, and/or the Internet.

FIG. 3B illustrates an exemplary thick client implementation in which the user interface 50 and the controller 60 reside at a user computer device 320 (which may be similar to computer system 12 of FIG. 1). The computer device 320 communicates with the pipelines and tag libraries 80a-n and the big data platform 70 via the network 315. The pipelines and tag libraries 80a-n may be implemented on a single computer device 322 or on multiple computer devices at nodes in a distributed network environment.

FIG. 3C illustrates an exemplary thin client implementation in which the user interface 50 resides at a user computer device 330 (which may be similar to computer system 12 of FIG. 1). The computer device 330 communicates with the controller 60, the pipelines and tag libraries 80a-n, and the big data platform 70 via the network 315. The controller 60 and the pipelines and tag libraries 80a-n may be implemented on a single computer device 332 or on multiple computer devices at nodes in a distributed network environment.

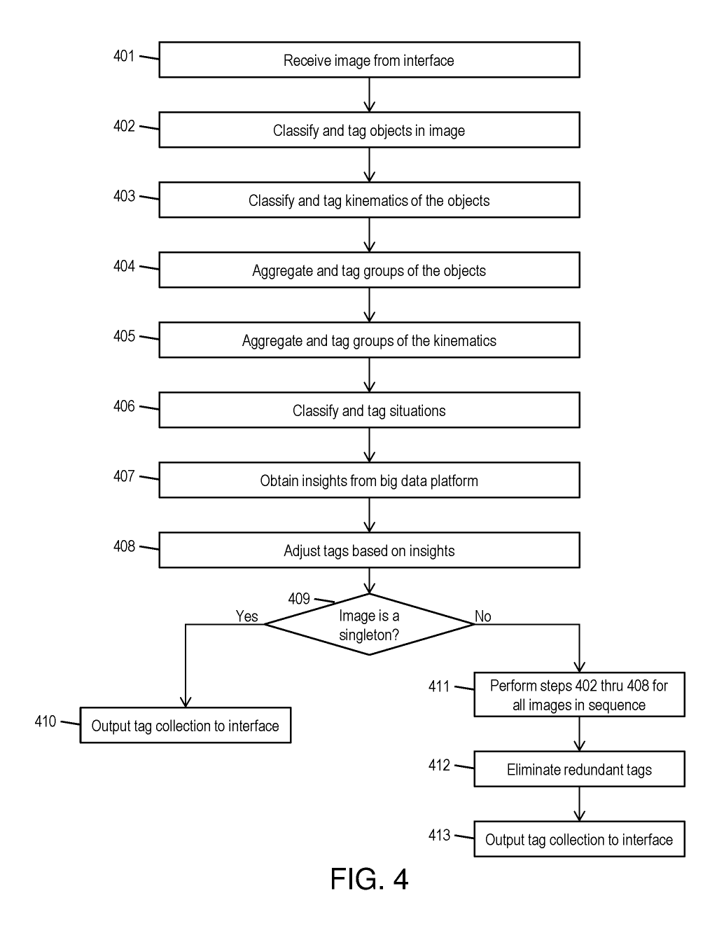

FIG. 4 shows a flowchart of a method in accordance with aspects of the invention. Steps of the method of FIG. 4 may be performed in the system illustrated in FIG. 2 and are described with reference to elements and steps described with respect to FIG. 2. The method can be used for operating a computer-based conversation system that interacts with a human user.

At step 401, the system 48 receives an input of an image. In embodiments, as described with respect to FIG. 2, a user inputs an image to be tagged at a user interface 50.

At step 402, the system 48 classifies and tags objects in the image that was input at step 401. In embodiments, as described with respect to FIG. 2, the user interface 50 passes the image to a controller 60, and the controller passes the image to an object tagging module comprising “Pipeline 1” and the “Template to Object Tag Library”. As described with respect to FIG. 2, “Pipeline 1” operates to classify objects in the image using template based techniques, and to annotate (tag) the objects using tags from the “Template to Object Tag Library” based on the classification.

At step 403, the system 48 classifies and tags kinematics of the objects in the image that was input at step 401. In embodiments, as described with respect to FIG. 2, the controller 60 passes the image to a kinematic tagging module comprising “Pipeline 2” and the “Template to Kinematic Tag Library”. As described with respect to FIG. 2, “Pipeline 2” operates to classify kinematics aspects of the objects in the image using template based techniques, and to annotate (tag) the kinematics using tags from the “Template to Kinematic Tag Library” based on the classification.

At step 404, the system 48 aggregates and tags groups of the objects in the image that was input at step 401. In embodiments, as described with respect to FIG. 2, the controller 60 passes the image to an object aggregation tagging module comprising “Pipeline 3” and the “Template to Object Aggregation Tag Library”. As described with respect to FIG. 2, “Pipeline 3” is configured to classify an aggregation of the one or more objects in the image and to annotate the one or more objects with one or more tags from the “Template to Object Aggregation Tag Library” based on the classification.

At step 405, the system 48 aggregates and tags groups of kinematics in the image that was input at step 401. In embodiments, as described with respect to FIG. 2, the controller 60 passes the image to a kinematic aggregation tagging module comprising “Pipeline 4” and the “Template to Kinematic Aggregation Tag Library”. As described with respect to FIG. 2, “Pipeline 4” is configured to classify an aggregation of a kinematic aspect of the one or more objects in the image and to annotate the one or more objects with one or more tags from the “Template to Kinematic Aggregation Tag Library” based on the classification.

At step 406, the system 48 aggregates and tags situations in the image that was input at step 401. In embodiments, as described with respect to FIG. 2, the controller 60 passes the image to a situation tagging module comprising “Pipeline n” and the “Template to Situation Tag Library”. As described with respect to FIG. 2, “Pipeline n” is configured to classify a situation in the image and to annotate the situation with one or more tags from the “Template to Situation Tag Library” based on the classification.

At step 407, the system 48 obtains insights from a big data platform. In embodiments, as described with respect to FIG. 2, the controller 60 passes the image, data defining the tagged objects, and the identity of the user to a big data platform 70, which uses big data analytics to obtain insights about one or more of the objects in the image (e.g., one or more of the objects classified and tagged in “Pipeline 1”). Step 407 may include the controller 60 receiving the determined insights from the big data platform 70.

At step 408, the system 48 adjusts tags based on the insights obtained from the big data platform. In embodiments, as described with respect to FIG. 2, the controller 60 may replace generic tags (e.g., “dog”) with personalized tags (“Fido”) based on the insights obtained from the big data platform. Additionally or alternatively, the controller may replace generic tags (e.g., “man”) with age/time change tags (“Tom when he was younger”) based on the insights obtained from the big data platform.

At step 409, the system 48 determines whether the image from step 401 is a singleton (i.e., a single image), which may be performed using conventional techniques. In the event that the image is a singleton, then at step 410 the system 48 outputs the tag collection. In embodiments, as described with respect to FIG. 2, the controller 60 arranges the tags in a sentence, and outputs the sentence to the user interface 50.

In the event that the image is not a singleton (i.e., the image is a sequence of plural images), then at step 411 the system performs steps 402 thru 408 for each respective image in the sequence of images.

At step 412, the system 48 eliminated redundant tags from consecutive images in the sequence. In embodiments, as described with respect to FIG. 2, the sequence tagging module 96 compares tags of consecutive images in the sequence and eliminates redundant tags from a subsequent image. In this manner, the system is configured to annotate the sequence of images by tagging the first image and tagging changes that occur from one image to the next after the first image.

At step 413, the system 48 outputs the tag collection. In embodiments, as described with respect to FIG. 2, the controller 60 arranges the tags in a sentence, and outputs the sentence to the user interface 50.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-10. (canceled)

11. A system for classifying and tagging digital images, comprising:
a CPU, a computer readable memory, and a computer readable storage medium associated with a computer device;
program instructions defining plural pipelines each configured to classify and tag aspects of the image, wherein a first one of the plural pipelines is configured to classify and tag an object in the image, and a second one of the plural pipelines is configured to classify and tag a kinematic aspect of the object in the image;
program instructions defining a controller configured to: pass the image to each of the plural pipelines in a predefined order; and output an annotation of the image to a user interface, wherein the program instructions are stored on the computer readable storage medium for execution by the CPU via the computer readable memory.

12. The system of claim 11, wherein the plural pipelines comprise:
a pipeline configured to classify and tag an aggregation of objects in the image;
a pipeline configured to classify and tag an aggregation of the kinematic aspects of the objects in the image; and
a pipeline configured to classify and tag a situation in the image.

13. The system of claim 11, wherein the first one of the plural pipelines classifies the object by comparing a shape of the object to predefined object templates.

14. The system of claim 11, wherein the second one of the plural pipelines classifies the kinematic aspect of the object by comparing a shape of the object to predefined kinematic templates.

15. The system of claim 11, wherein the controller is configured to:
obtain an insight about the object in the image from a big data platform; and
adjust an object tag of the image based on the insight.

16. The system of claim 15, wherein the adjusting the object tag comprises replacing the object tag with one of a name, a relationship, and an age descriptor.

17. The system of claim 11, wherein the image comprises a sequence of plural images, and the controller is configured to:
pass each one of the plural images to each of the plural pipelines; and
eliminate redundant tags from consecutive ones of the plural images.

18. A computer program product for classifying and tagging digital images, the computer program product comprising a computer readable storage medium having program instructions embodied therewith, the program instructions executable by a computer device to cause the computer device to:
receive an input of an image from a user interface;
tag the image with at least one object tag using an object tagging pipeline;
tag the image with at least one kinematic tag using a kinematic tagging pipeline;
obtain at least one insight about the image from a big data platform;
tag the image with at least one personalized object tag based on at least one object tag and the at least one insight;
generate an annotation of the image based on the at least one personalized object tag and the at least one kinematic tag; and
output the annotation to the user interface.

19. The computer program product of claim 18, wherein the object tagging pipeline classifies the at least one object by comparing a shape of the at least one object to predefined object templates.

20. The computer program product of claim 18, wherein the kinematic tagging pipeline classifies a kinematic aspect of the at least one object by comparing a shape of the at least one object to predefined kinematic templates.
